(19) United States
(12) Patent Application Publication
(10) Pub. No.: US 2007/0172633 A1
(43) Pub. Date: Jul. 26, 2007

(54) TRANSPORT BELT

(75) Inventors: Arved H. WESTERKAMP, Dettingen/Erms (DE); Hubert WALKENHAUS, Kerpen (DE)

Correspondence Address: GREENBLUM & BERNSTEIN, P.L.C., 1950 ROLAND CLARKE PLACE, RESTON, VA, 20191, US

(73) Assignee: VOITH PATENT GMBH, Heidenheim (DE)

(21) Appl. No.: 11/626,654

(22) Filed: Jan. 24, 2007

(30) Foreign Application Priority Data
Jan. 26, 2006 (DE) 10 2006 003 703.0

(51) Int. Cl. B32B 3/00

(52) U.S. Cl. 428/141

(57) ABSTRACT

A transport belt including a belt core and a web material contact layer carried by the belt core. The web material contact layer includes a structured surface for contacting a product to be produced or processed, and has a hardness greater than a hardness of the belt core. The instant abstract is neither intended to define the invention disclosed in the specification nor intended to limit the scope of the invention in any way.

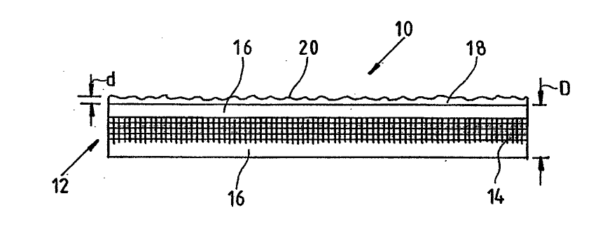

### CROSS-REFERENCE TO RELATED APPLICATIONS

The present invention claims priority under 35 U.S.C. §119 of German Patent Application No. 10 2006 003 703.0 filed on Jan. 26, 2006, the disclosure of which is expressly incorporated by reference herein in its entirety.

### BACKGROUND OF THE INVENTION

1. Field of the Invention

The invention relates to a transport belt that can be used, for example, on machines with which paper, paperboard, or the like, is produced or processed.

2. Discussion of Background Information

European Patent Application Publication No. EP 0 576 115 A1 discloses a transport belt that transports a paper layer through various processing stations in the paper production process. This known transport belt is constructed with a core region which provides the belt's carrying structure and has fiber material in the form of a fabric in its inside structure. A coating of elastic material is disposed on a side provided for contacting the paper. This coating is structured on its surface, which comes into contact with the paper, by performing a grinding operation. This structuring, in conjunction with the comparatively elastic material selected for the coating, results in the coating being compressed when the transport belt carrying a paper web is moved through the press nip formed between two transport rollers or press rollers and subjected thereby to a linear load. The compression results in a more or less smooth surface being provided at the interface to the paper. As the result of the compression, when water escapes from the paper and a water film is formed between the paper and the coating of the transport belt, the water film is not broken by the roughness of the coating. In the regions in which the paper web and the transport belt are separated, it is possible for the roughness existing in the unloaded state to be regained due to the elasticity of the coating providing the surface roughness. This results in interruption of the more or less continuous water film, preventing an undesirable adhesive effect between the transport belt and the paper web.

### SUMMARY OF THE INVENTION

The present invention relates to a transport belt for machines for the production or processing of web material such as paper, with which the method of processing or producing the web material is improved.

According to aspects of the invention, a transport belt includes a belt core and, on at least one side of the belt core, a web material contact layer which provides a structured surface intended for contacting the paper to be produced or processed. The web material contact layer has a greater hardness than the belt core and/or a carrier material of the belt core carrying the web material contact layer. The transport belt is useful, in particular, with machines for the production or processing of web material such as paper or paperboard.

Contrary to the transport belt known from the prior art, implementations of the current invention render the region with which the transport belt contacts the web material to be produced or processed relatively hard. As a result, even where high pressures or loads occur during the processing operation, the structuring provided in the web material contact layer remains essentially unchanged (i.e., the web material contact layer is essentially not compressed). Consequently, the recesses or depressions arising from the structuring provided in this web material contact layer or in the region adjacent the web material to be produced are preserved and can accommodate liquid (e.g., water which escapes from the web material). In those regions where the web material and the transport belt are again separated from each other, the risk of liquid, which had previously emerged from the web material due to the compressive load, being absorbed again in the web material is reduced. This is due to the liquid being held in and carried by the depressions of the transport belt. Similarly, the risk of an adhesive effect generated by a continuous water film is practically eliminated because the creation of a continuous water film is prevented by the structuring of the web material contact layer, which exists even under compressive loading.

In embodiments of the invention, the structuring has a Shore A hardness value of at least 97. This preserves the structuring of the web material contact layer even under comparatively high compressive loads.

According to aspects of the invention, the web material contact layer is constructed from hydrophilic material for providing as uniform a wetting and liquid absorption as possible. The hydrophilic material is preferably polymer material, such as, for example, epoxide resin.

In implementations of the invention, the web material contact layer has a thickness in a range from 0.02 mm to 1.5 mm, preferably 0.03 mm to 0.7 mm. This provides the required hardness or rigidity in the region contacting the web material, while also guaranteeing the required flexibility of the transport belt.

In accordance with aspects of the invention, the web material contact layer is constructed such that it is essentially not compressed under the compressive loads arising during the processing operations, which, in the case of processing rollers pressing against each other, can lie at a linear pressure in the range from 20 kN/m to 1700 kN/m. As used herein, essentially not compressed refers to a change in thickness of less than 10% during compression as a result of application of the above-described pressures. Needless to say, a minimal change of thickness of the web material contact layer will arise from the above-described load. However, this will not result in the depressions provided by the structuring of the web material contact layer (or their accommodation volume) being reduced to the extent that the liquid emerging from the web material, or at least essential parts thereof, can no longer be accommodated therein.

Additionally, the belt core may comprise a central region and a carrier material at least partly surrounding and/or embedding the central region. This central region may carry the web material contact layer. Moreover, the carrier material may be constructed from polymer material, such as, for example, polyurethane resin. In order for the loads arising in the processing operation to be absorbed and evenly distributed in the transport belt, the central region may comprise fiber material, such as, for example, fiber fabric.

In embodiments, the belt core has a thickness in the range from 2 mm to 8 mm.

According to a first aspect of the invention, there is a transport belt including a belt core and a web material contact layer. The web material contact layer is carried by the belt core, comprises a structured surface for contacting a product to be produced or processed, and has a hardness greater than a hardness of the belt core.

The hardness of the web material contact layer may be at least 97 Shore A. Moreover, the web material contact layer may comprise hydrophilic material. The web material contact layer may comprise polymer material. The web material contact layer may comprise epoxide resin.

In embodiments, the web material contact layer has a thickness in a range of 0.02 mm and 1.5 mm, preferably in a range of 0.03 mm and 0.7 mm.

The web material contact layer may be essentially non-compressible under compressive loads arising during paper producing/processing operations. For example, the web material contact layer may be essentially non-compressible under compressive loads ranging from 20 kN/m to 1,700 kN/m.

The belt core may comprise a central region and a carrier material carrying the web material contact layer. The carrier material may at least one of at least partly surround and at least partly embed the central region. The carrier material may comprise polymer material. The carrier material may comprise polyurethane resin. The central region may comprise fiber material. The central region may comprise fiber fabric. The belt core may have a thickness in a range of 2 mm to 8 mm.

Additionally, the transport belt may be structured and arranged for use with machines for the production of paper or paperboard.

In a second aspect of the invention, there is a transport belt including a central region, a carrier material affixed to the central region, and a web material contact layer carried by the carrier material. The web material contact layer has a structured surface for contacting a product to be produced or processed, and has a hardness greater than at least one of a hardness of the central region and a hardness of the carrier material. Moreover, the hardness of the web material contact layer may be at least 97 Shore A, and the web material contact layer may be essentially non-compressible under compressive loads ranging from 20 kN/m to 1,700 kN/m.

According to a third aspect of the invention, there is a method of making paper, paperboard, or a paper product. The method includes transporting a web material on a structured surface of a web material contacting layer of a transport belt. The web material contacting layer is carried on a belt core of the transport belt and a hardness of the belt core is less than a hardness of the web material contacting layer. Furthermore, the web material contacting layer may be essentially non-compressible under compressive loads arising during paper producing/processing operations.

### BRIEF DESCRIPTION OF THE DRAWING

The present invention is further described in the detailed description which follows, in reference to the noted drawing by way of non-limiting examples of exemplary embodiments of the present invention, wherein:

The FIGURE shows a schematic cross-sectional view of an inventive transport belt.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawing making apparent to those skilled in the art how the several forms of the present invention may be embodied in practice.

The FIGURE shows, in cross section, an example of an inventive transport belt 10 that can be used in the production of paper webs or other web material (e.g., paperboard webs, etc.). The transport belt 10 comprises a belt core 12 which makes up an essential thickness range or volume fraction of the transport belt 10. The thickness “D” of the belt core 12 can lie, depending on the web material to be produced and the processing operation to be performed, in the range from 2 mm to 8 mm. Disposed in the center of the belt core 12 is a fiber material 14 that provides structural strength in the plane of the transport belt 10. In embodiments, the fiber material 14 comprise a polymer fiber material, and may further comprise a fiber fabric. However, it is also possible to provide non-woven material, such as, for example, individual fibers extending in the machine direction or transverse to the machine direction. The fiber material 14 is preferably surrounded on both sides by a carrier material 16 or is embedded in the carrier material 16. In implementations, the carrier material 16 is a relatively soft or elastic polymer material, such as, for example, polyurethane. The carrier material 16, in conjunction with the fiber material 14, provides sufficient flexibility in the central region of the belt core 12 such that the transport belt 10 can be guided and deflected over rollers.

A contact layer 18 is provided on at least one side of the belt core 12. This contact layer 18 is provided on the side of the belt core 12 that is to come into contact with the web material to be processed or produced (e.g., the paper web). The other side of the belt core 12 is guided over rollers and, therefore, is configured (for example, by way of a suitable coating or choice of material) to meet the requirements arising thereby.

The contact layer 18 completely covers the belt core 12 on its side facing the web material to be processed. That is, at least that region of the transport belt 10 which comes into direct contact with the web material is covered with the contact layer 18. As shown in the FIGURE, the contact layer 18 is thinner than the belt core 12. For example, the contact layer 18 has a thickness “d” in the range from 0.02 mm to 1.5 mm, and preferably in the range of 0.03 mm to 0.7 mm. As further depicted in the FIGURE, the contact layer 18 is structured (i.e., is not constructed to be smooth or flat) on its side 20 coming into direct contact with the web material. As used herein, structured refers to elevation regions and depression regions such that, for example, the depressions formed below the highest elevation regions create a volume in which liquid (e.g., water) emerging from the web material to be processed or produced can be accommodated during the processing operation.

In order to ensure or preserve the ability to accommodate liquid emerging from the web material during the processing operation, the contact layer 18 is constructed from a material which is essentially non-compressible under the compressive loads experienced in the processing operation. The compressive load arising in the nip between two rollers can lie, in terms of linear force, in the range from 20 kN/m to 1,700 kN/m. In this force range, the contact layer 18 is be essentially non-yielding (i.e., the change of volume and/or the change of thickness of the contact layer 18 is less than 10% in this force range). Given these compressive loads, the volume provided for accommodating liquid will necessarily change accordingly, but only by a minimal amount.

In embodiments, the contact layer 18 is constructed from epoxide resin to provide the above-described non-compressible behavior. This material is harder than the carrier material 16 and has preferably a Shore A hardness of at least 97. In further embodiments, the contact layer 18 comprises a hydrophilic material. This improves the ability of transport belt 10 to discharge liquid emerging from the layer of web material to be processed, thereby leading to as uniform a wetting as possible and promoting the carrying along of liquid during separation of the transport belt 10 from the web material.

According to aspects of the invention, it is possible to influence the behavior of the transport belt 10 through the configuration of the contact layer 18 and of the belt core 12 (e.g., through selection of the materials used). For example, depending on the intended application of the transport belt 10, the belt core 12 and the contact layer 18 can be constructed to be permeable or impermeable for liquid and/or air. Also, in implementations, it is possible to use a construction material whose material properties (e.g, elasticity, hardness, etc.) are temperature-dependent, which can be influenced by varying the temperature of the transport belt.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A transport belt, comprising:
a belt core; and
a web material contact layer carried by the belt core and comprising a structured surface for contacting a product to be produced or processed, and having a hardness greater than a hardness of the belt core.

2. The transport belt of claim 1, wherein the hardness of the web material contact layer is at least 97 Shore A.

3. The transport belt of claim 1, wherein the web material contact layer comprises hydrophilic material.

4. The transport belt of claim 1, wherein the web material contact layer comprises polymer material.

5. The transport belt of claim 1, wherein the web material contact layer comprises epoxide resin.

6. The transport belt of claim 1, wherein the web material contact layer has a thickness in a range of 0.02 mm and 1.5 mm.

7. The transport belt of claim 1, wherein the web material contact layer has a thickness in a range of 0.03 mm and 0.7 mm.

8. The transport belt of claim 1, wherein the web material contact layer is essentially non-compressible under compressive loads arising during paper producing/processing operations.

9. The transport belt of claim 1, wherein the web material contact layer is essentially non-compressible under compressive loads ranging from 20 kN/m to 1,700 kN/m.

10. The transport belt of claim 1, wherein the belt core comprises a central region and a carrier material carrying the web material contact layer.

11. The transport belt of claim 10, wherein the carrier material at least one of at least partly surrounds and at least partly embeds the central region.

12. The transport belt of claim 10, wherein the carrier material comprises polymer material.

13. The transport belt of claim 10, wherein the carrier material comprises polyurethane resin.

14. The transport belt of claim 10, wherein the central region comprises fiber material.

15. The transport belt of claim 10, wherein the central region comprises fiber fabric.

16. The transport belt of claim 10, wherein the belt core has a thickness in a range of 2 mm to 8 mm.

17. The transport belt of claim 1, wherein the transport belt is structured and arranged for use with machines for the production of paper or paperboard.

18. A transport belt, comprising:
a central region;
a carrier material affixed to the central region; and
a web material contact layer carried by the carrier material, comprising a structured surface for contacting a product to be produced or processed, and having a hardness greater than at least one of a hardness of the central region and a hardness of the carrier material.

19. The transport belt of claim 18, wherein:
the hardness of the web material contact layer is at least 97 Shore A, and
the web material contact layer is essentially non-compressible under compressive loads ranging from 20 kN/m to 1,700 kN/m.

20. A method of making paper, paperboard, or a paper product, comprising:
transporting a web material on a structured surface of a web material contacting layer of a transport belt,
wherein the web material contacting layer is carried on a belt core of the transport belt and a hardness of the belt core is less than a hardness of the web material contacting layer.

21. The method of claim 20, wherein the web material contacting layer is essentially non-compressible under compressive loads arising during paper producing/processing operations.
